(19) United States
(12) Patent Application Publication
(10) Pub. No.: US 2017/0193595 A1
(43) Pub. Date: Jul. 6, 2017

(54) METHODS, SYSTEMS, AND COMPUTER READABLE MEDIA FOR ELECTRONICALLY GUARANTEEING RENT PAYMENT

(71) Applicant: MasterCard International Incorporated, Purchase, NY (US)

(72) Inventors: Andres Guillermo Lopez, Yonkers, NY (US); Juan Carlos Leonardo Wiley Garcia, Ossining, NY (US); John Anthony Gioacchini, Yorktown Heights, NY (US); Bryan Jacob Wexler, Melville, NY (US); Stephen Anthony Parento, White Plains, NY (US)

(21) Appl. No.: 14/985,936

(22) Filed: Dec. 31, 2015

(51) Int. Cl. G06Q 30/06; G06Q 20/10

(52) U.S. Cl. CPC G06Q 30/0645; G06Q 20/102

(57) ABSTRACT

Methods, systems, and computer readable media for electronically guaranteeing rent payment are provided. An exemplary method includes electronically receiving, by a payment program platform, monetary funds to be deposited in a payment card account hosted by the payment program platform and designating at least a portion of the received monetary funds as allocated rent payment funds in accordance to a rent payment policy. The method further includes electronically providing the allocated rent payment funds to a rent payment management server (RPMS) for storage and electronically releasing, by the RPMS, an accumulated amount of monetary funds that includes the allocated rent payment funds to a landlord entity in accordance to the rent payment policy.

### TECHNICAL FIELD

The subject matter described herein relates to improved methods and systems for electronically allocating funds for payment of rent. More particularly, the subject matter described herein relates to systems, methods, and computer readable media for electronically guaranteeing rent payment.

### BACKGROUND

In certain situations, various individuals may experience difficulty leasing or renting an apartment, house, or other property. Such individuals may encounter difficulties for any number of reasons, including insufficient or non-existent credit history, unsatisfactory credit scores, inability to provide a sufficient security deposit, and the like. Notably, these situations are problematic to all the parties involved, since underserved individuals may not readily have access to adequate housing while landlord entities lack incentive to provide rental housing to individuals who may otherwise be able to afford it.

Accordingly, there exists a need for improved methods, systems, and computer readable media for electronically guaranteeing rent payments.

### SUMMARY

According to one aspect, the subject matter described herein relates to methods, systems, and computer readable media for electronically guaranteeing rent payment. An exemplary method includes electronically receiving, by a payment program platform, monetary funds to be deposited in a payment card account hosted by the payment program platform and designating at least a portion of the received monetary funds as allocated rent payment funds in accordance to a rent payment policy. The method further includes electronically providing the allocated rent payment funds to a rent payment management server (RPMS) for storage and electronically releasing, by the RPMS, an accumulated amount of monetary funds that includes the allocated rent payment funds to a landlord entity in accordance to the rent payment policy.

The subject matter described herein may be implemented in hardware, software, firmware, or any combination thereof. As such, the terms “function”, “node”, or “module” as used herein refer to hardware, which may also include software and/or firmware components, for implementing the features being described. In one exemplary implementation, the subject matter described herein may be implemented using a non-transitory computer readable medium having stored thereon computer executable instructions that when executed by the processor and memory of a computer control the computer to perform steps.

Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The subject matter described herein includes exchanging messages across a packet-based communications network, wherein the messages include payloads containing payment information (payment card numbers, account data, or the like), balance information, and/or transaction information associated with guaranteeing the electronic payment of rent. The subject matter described herein also includes implementing electronic pre-allocation or designation of monetary funds, to effectively place a hold (e.g., place a lien, store in escrow, etc.) on those funds until a predetermined settlement date such that the funds can only be used for rent payments. In some embodiments, implementing an electronic guarantee for rent payments includes invoking one or more application programming interfaces (APIs) configured to assist otherwise distinct applications with sharing data across a packet-based network.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a schematic diagram illustrating exemplary network architecture for electronically guaranteeing rent payments according to an embodiment of the subject matter described herein;

FIG. 2 is a diagram illustrating exemplary electronic messaging exchanged between various computing entities for electronically guaranteeing rent payments according to an embodiment of the subject matter described herein;

FIG. 3 is a block diagram illustrating an exemplary system for electronically guaranteeing rent payments according to an embodiment of the subject matter described herein; and

FIG. 4 is a flow diagram illustrating an exemplary process for electronically guaranteeing rent payments according to an embodiment of the subject matter described herein.

### DETAILED DESCRIPTION

In accordance with the subject matter disclosed herein, methods, systems, and computer readable media for electronically guaranteeing rent payment are provided. In some embodiments, methods, systems, and computer readable media described herein for facilitating the management and settlement of rent payments are not manual (e.g., incapable of being performed or executed by a human being), but rather are accomplished by virtue of electronic messaging exchanged between network entities (e.g., computer platforms, electronic entities, or nodes) across a packet-based communications network. For example, the disclosed subject matter may utilize electronic allocation or “earmarking” of monetary funds in a payment card account to conduct rent payments on a periodic basis. The methods, systems, and computer media described herein advantageously obviate the need for performing manual processes (e.g., delivering a check or cash as rent payment, designating specific electronic deposits for rent payment, etc.) on a recurring basis, thereby expanding the accessibility of rental property to larger portions of the population via the electronic guarantee of rent payments.

The methods, systems, and computer readable media described herein advantageously benefit multiple parties to a rent agreement and/or transaction, including the lessee entity (e.g., also referred to as a “renter”, “renter entity”, “user”, and/or a “cardholder”) and the lessor entity (e.g., also referred to as a “landlord entity”). For the sake of illustration and clarity, the following description may also reference a “renter” or a “renter entity” to respectively mean a “prospective renter” or “prospective renter entity”. Notably, electronically guaranteeing rent payment provides a landlord entity with an increased level of assurance that a renter can pay for the rented property on a periodic basis, while the renter may experience benefits, such as receiving a discounted rent amount, establishing a lease irrespective of non-existent or poor credit history, precluding the need for a security deposit, and/or similar incentives.

As used herein, the term “allocating” refers to electronically earmarking, identifying, and/or otherwise designating monetary funds to be used to pay a specific rent payment, or portions thereof, on a recurring or periodic basis (e.g., weekly or monthly rent). The allocation of funds in a renter's payment card account (e.g., a prepaid card account, a bank card account, a credit card account, etc.) may be used to designate particular funds for electronic transfer to a third party storage. Notably, the transferred funds may be accumulated and held during a particular payment period (e.g., a month prior to a rent settlement/transaction due date). Electronically allocating, collecting, and/or holding funds associated with a renter's payment card account facilitates a continual guarantee for landlord entities, which provides incentives for said landlord entities to participate in the rent payment transactions described herein.

Reference will now be made in detail to exemplary embodiments of the subject matter described herein, examples of which are illustrated in the accompanying drawings. Wherever possible, the same reference numbers will be used throughout the figures and refer to the same or like entities.

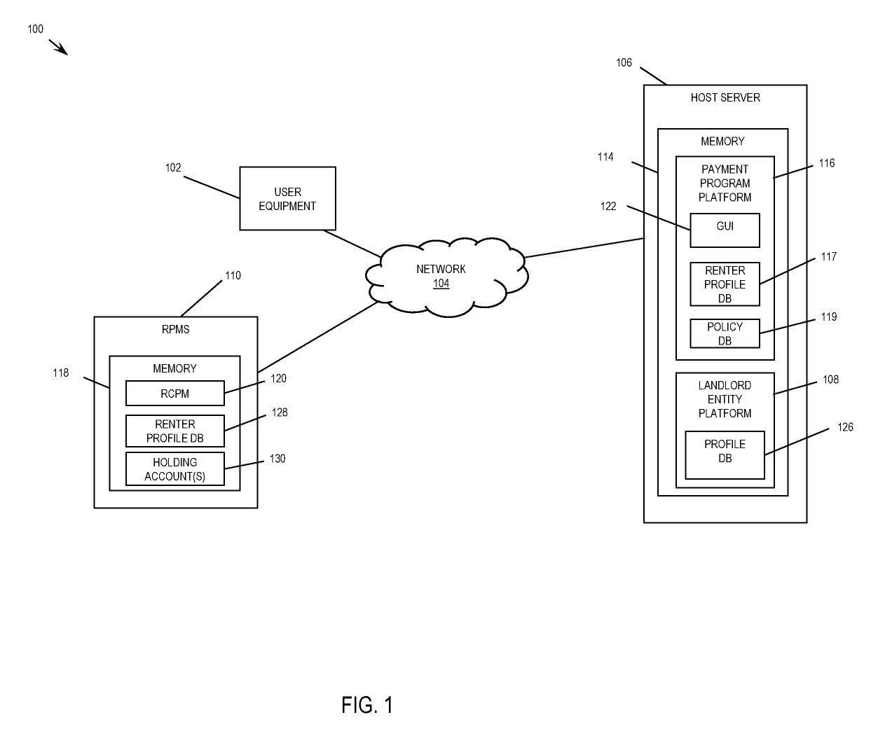

FIG. 1 is a schematic diagram illustrating an exemplary network environment or network system 100 associated with electronically guaranteeing rent payment according to an embodiment of the subject matter described herein. In some embodiments, system 100 includes different and/or distinct network nodes or entities for facilitating the payment of rent via the designation or earmarking of monetary funds on a recurring basis. For example, system 100 may include a user equipment (UE) 102, a host server 106, and a rent payment management server (RPMS) 110 that are communicatively connected via a communications network 104.

In some embodiments, communications network 104 includes a packet-based communications network (e.g., the Internet). Network 104 facilitates communication of data via packets and/or packet-based messages, which may be communicated between network entities according to any desired communication protocol as known in the art (e.g., IP, HTTP, TCP, UDP, SIP, or the like). Network 104 may be accessed via one or more access nodes, endpoints, or ingress points such as one or more gateways or switches (not shown). For illustration purposes only, a single network 104 is illustrated in for generically depicting the Internet or cloud in FIG. 1. Network 104 may support one or more cloud based entities or services and may also include and/or facilitate communications for a plurality of different (e.g., individual or privately managed) networks. In some embodiments, network 104 may also support communications across different networks for accessing rent payment allocation and collection services hosted by various individual entities, such host server 106 and/or RPMS 110.

In some embodiments, UE 102 may include any type of mobile or non-mobile device such as a phone, a computer, a smartphone device, a laptop computer, a tablet computer, a desktop computer, a smart planner or organizer, a smart television, a wearable computer (e.g., a watch or eyeglass mounted computer), or the like. Notably, UE 102 may access network 104 via signaling across any type of wired or wireless connection or interface (e.g., a WAN, a LAN, a WiFi connection, a radio access network connection, or the like). In some embodiments, UE 102 may include any electronic device configured to access a payment program platform 116 that is supported by a host server 106 via communication network 104 as described below.

In some embodiments, host server 106 may be managed and maintained by a third party entity (e.g., a payment clearinghouse, or the like) that is responsible for enrolling prospective renters into a payment card account (e.g., prepaid or non-prepaid card account) that is associated with a rent payment collection service. The rent payment collection service may include both a “renter facing” payment program platform 116, which is accessible by UE 102, as well as a “landlord entity facing” platform 108, which is accessible by a landlord entity using a device similar to UE 102. More specifically, host server 106 can advantageously be accessed by a plurality of different parties to a lease and/or rent payment transaction. For example, renters can access host server 106 across network 104 using UE 102. Similarly, landlord entities using a UE (not shown) may also access host server 106 to enroll and manage accounts via signaling packet communications across network 104. For example, payment program platform 116 supported by host server 106 allows a renter to view a rent payment, set up a payment schedule by which monetary funds will be placed on hold and/or designated for payment of rent, and view rent account balances or account information. In some embodiments, the landlord entity platform 108 of the rent payment collection service may be supported by a network element that is separate and distinct from host server 108 (e.g., a second host server).

In some embodiments, host server 106 supports a graphical user interface (GUI) 122 by which the renter can enroll in a rent payment program service (see below), view past rent payments, set up recurring payments, determine a payment schedule, view a rent account balance, or the like. GUI 122 can comprise a display or interface by which a renter can determine an amount of funds that is to be allocated for payment to a landlord entity in each payment cycle (e.g., monthly rent). In some embodiments, GUI 122 includes a mobile application or website access interface associated with a third party service provider that is independent from the landlord entity.

In some embodiments, RPMS 110 includes a special purpose centralized clearing and/or settlement device or server for managing funds (e.g., designating funds) and settling of financial transactions the rent payment program service participants (e.g., renters, landlord entities, or the like). RPMS 110 includes functionality for pre-authorizing and holding funds for satisfying rent payments until a predetermined settlement date. This advantageously provides landlord entities assurance that the renter has sufficient funds to pay for rent according to a recurring schedule.

In some embodiments, payment program platform 116 and RPMS 110 communicate and/or exchange account and payment information via an application programming interface (API) configured to facilitate the communication of data. Payment program platform 116 is configured for and/or has functionality for managing rent account information, rent balance information, or the like, and presenting such information to the renter via GUI 122. Payment program platform 116 also includes functionality for receiving rent transaction confirmation information, rent transaction history information, and/or account balance information from RPMS 110. In some embodiments, RPMS 110 includes a rent collection and payment module (RCPM) 120 (which is stored in local memory 118) for querying payment program platform 116 to periodically determine if any monetary funds from a recent deposit have been allocated and/or earmarked in a renter's payment card account.

RPMS 110 is further configured to receive the earmarked monetary funds designated funds for rent payments from host server 106. Upon receipt, RPMS 110 may be configured to place an electronic hold (e.g., a lien) on the allocated funds, thereby storing these funds until release to the landlord entity per the rent payment policy. Notably, the accumulated monetary funds will have an electronic hold applied by RPMS 110 such that the held funds can only be used for payment of rent at a particular date and/or time (as indicated in the rent payment policy).

In some embodiments, a prospective renter utilizing user equipment (UE) 102 can enroll or register in a rent payment program configured to electronically collect, allocate, and/or earmark monetary funds, and subsequently release the accumulated funds to a landlord entity on a recurring basis as established per a predetermined schedule (e.g., a daily, weekly, monthly, bi-weekly, quarterly schedule, or the like). Notably, system 100 obviates the need for the traditional (i.e., manual) delivery, collection, and payment of rent. In addition, a landlord entity is incentivized to accept a greater number of prospective individual renters due to the guaranteeing of electronic rent payments.

For example, landlord entity platform 108 in host server 106 may be configured to receive enrollment and/or registration data from at least one landlord entity (e.g., lessor entity 108). For example, a landlord entity (e.g., a landlord, a property manager, etc.) may access platform 108 via website access and register as a landlord entity participant. Further, the landlord user may use a website interface of platform 108 to construct a landlord entity profile that specifies the property for rent as well as certain rental agreement criteria associated with the rental property. For example, the specified rental agreement criteria may include i) a rent due date, ii) the (monetary) amount of rent, iii) a specified discount amount to be applied to the rent amount (if applicable), iv) the time length of the lease, v) a due date for the rent payment, and/or other information/terms typically included in a lease for rental property. After the landlord profile is created, the landlord entity profile is stored as an entry in a landlord profile database 126 until a matching prospective renter entity (i.e., currently existing or forthcoming) is identified. In some embodiments, the landlord entity profile also includes an account number or identifier corresponding to an account (e.g., a bank account, a payment card account, etc.) belonging to the landlord entity. In some embodiments, platform 108 may generate a payment card account associated with the created landlord profile (associated with the rent payment service).

Similarly, payment program platform 116 in host server 106 may be configured to receive enrollment and/or registration data from a plurality of renter entities (e.g., via UE 102). For example, a prospective renter may access payment program platform 116 via website access and enroll as a renter participant. Further, the user may construct (via a website supported by payment program platform 116) a renter profile that includes renter criteria. The renter criteria may specify the type of desired property that is desired by the renter (e.g., an apartment, house, etc.), the number of desired bedrooms, a specified rent amount or a range of acceptable rent amounts, the geographical location of the rental property (e.g., a particular apartment complex, neighborhood, postal zip code, etc.), the time length of the lease (e.g., months and/or years), and/or other information/terms typically included in a lease for rental property. After the renter profile is created, it is stored as an entry in renter profile database 117 until a matching landlord entity (i.e., currently existing or forthcoming) is identified. In some embodiments, payment program platform 116 may generate a payment card account associated with the created renter profile (associated with the rent payment service). Notably, the payment card account identifier is included in the renter profile along with the renter criteria.

In some embodiments, payment program platform 116 is configured to assess (e.g., compare and/or contrast) whether the renter criteria specified in a renter profile matches the rental agreement criteria specified in any one of the landlord profiles contained in database 126. For example, payment program platform 116 may be configured to calculate a correlation score based on the number of criteria instances found in the landlord profile and the render profile match (e.g., matching desired rent amount, matching length of desire lease, matching number of desired bedrooms, etc.). Upon using the landlord profile criteria and renter profile criteria to determine an adequate match between a renter profile entry and a landlord entity profile entry, payment program platform 116 may be configured to send a query message (e.g., a text message, an email message, etc.) to the renter entity to determine and/or confirm that the renter finds the landlord profile criteria acceptable and intends to comply with the conditions (e.g., rent amount, rent due date, etc.) specified in the matching landlord profile criteria.

In alternate embodiments, payment program platform 116 may be configured to permit the renter entity to search and view the landlord entity profiles in database 126 to determine if there is a landlord profile whose terms and conditions would be largely acceptable (e.g., a landlord profile that, while not necessarily match, may be of interest to the renter entity). Upon identifying a landlord profile with acceptable criteria, payment program platform 116 may be configured to receive a request message from the renter entity indicating and/or confirming that the renter finds the landlord profile criteria acceptable and intends to comply with the conditions (e.g., rent amount, rent due date, etc.) specified in the matching landlord profile criteria.

After establishing a match between the renter entity and the landlord entity, payment program platform 116 may generate rent payment policy data based on the rental agreement criteria established by the landlord entity. In some embodiments, the rent payment policy data may include elements specified in the renter criteria (if agreed upon by the landlord entity). After generating the rent payment policy data, payment program platform 116 may generate a corresponding rent payment policy record and store it in policy database 119.

In some embodiments, RPMS 110 is configured to receive an electronic communication containing the rent payment policy record from payment program platform 116, which includes a rent transaction amount (e.g., an amount owed), an identifier associated with the landlord entity entitled to the rent, or the like. The rent payment policy record may further include the rent transaction and/or settlement date (i.e., when the landlord entity actually receives the funds designated for rent), which is established by the criteria agreed upon by the landlord entity and the renter. The rent payment policy record may also comprise data indicating the payment card account number and other information that enables RPMS 110 to query a payment card account and transfer earmarked funds from the payment card account on host server to storage in RPMS 110. In some embodiments, RPMS 110 may store the rent payment policy record for each respective renter entity in a local renter profile database 128.

In some embodiments, payment program platform 116 is configured to allocate funds included in a payment card account belonging to a participant/renter. Notably, such monetary funds may be electronically deposited by the renter's employer, a government agency (e.g., Social Security Administration), and/or by the renter himself. In some embodiments, payment program platform 116 allocates monetary funds deposited in the renter's payment card account per the rent payment policy. For example, if a monthly rent is $800, the rent payment policy may include an allocation rule that indicates that the first $800 deposited into the payment card account is electronically designated for rent payment. Alternatively, the rent payment policy may include an allocation rule that indicates that a percentage (e.g., 75%) of every deposit is designated as rent payment (i.e., up to the $800 rent amount). Notably, the allocation rules included in the rent payment policy may be configurable by the landlord entity and/or the renter. In some embodiments, payment program platform 116 may be configured to designate or earmark funds in the renter's payment card account by electronically appending a tag or identifier to a deposit amount or some other subset amount of monetary funds contained in the payment card account. In other embodiments, payment program platform 116 may allocate the monetary funds in the payment card account based on a “first in, first out” basis (i.e., first $800 deposited is earmarked and subsequently transferred to RPMS 110 as described below).

After payment program platform 116 allocates and/or earmarks an amount of monetary funds for rent payment, RPMS 110 may attempt to pull the earmarked/allocated monetary funds from the renter's payment card account. In some embodiments, payment program platform 116 sends an electronic message to RPMS 110 to trigger RPMS 110 to pull earmarked monetary funds from the renter's payment card account. In some embodiments, RPMS 110 sends query messages to payment program platform 116 on a periodic basis (e.g., as established per the rent payment policy record) to inquire whether any existing funds in the payment card account has been allocated for rent payment.

In some embodiments, RPMS 110 may utilize an API to request allocated funds from payment program platform 116. In response, payment program platform 116 may identify the monetary funds earmarked for rent payment and transfers the same to RPMS 110 for storage. Upon receiving the rent payment policy information from payment program platform 116, RMPS 110 may be configured to establish a holding account (e.g., an escrow account) for the renter's monetary funds that have been designated and/or earmarked for the eventual release to the landlord entity. More specifically, RMPS 110 may establish and utilize a holding account (e.g., holding account 130) that is configured to periodically receive monetary funds associated with a particular renter entity from payment program platform 116. Alternatively, RPMS 110 may be configured to hold the funds in an existing holding account 130 for the renter thereby placing an electronic hold on these monetary funds. Notably, the hold assures a landlord entity that the agreed upon rent will be available for payment, or at least a portion thereof, on the rent transaction/settlement due date. More specifically, RMPS 110 may be triggered to release the stored monetary funds to the landlord entity upon the arrival of the rent transaction due date (e.g., as detected by RMPS 110 and/or payment program platform 116). If RMPS 110 determines that the rent due date has arrived, RPMS 110 is then configured to electronically release the designated funds to the appropriate landlord entity via landlord entity platform 108, and settling the rent transaction (if the released monetary funds amount to the rent amount). For example, landlord entity platform 108 may electronically receive the monetary funds from RPMS 110 and subsequently forward the monetary funds to an established account (e.g., a payment card account, a credit card account, a bank account, etc.) belonging to the landlord entity.

After performing this settlement of the rent payment, RPMS 110 is configured to signal rent transaction data and/or rent transaction history data to payment program platform 116 via packet network 104. Transaction data may include an electronic record indicating an amount of the rent transaction, the landlord entity name and/or identifier, the date/time of rent payment, a rent transaction identifier, or the like. Regardless of how rent payments are set up, transaction data can optionally be encrypted by RPMS 110, where desired, for protecting privacy and preventing security fraud. In some aspects, rent transaction data may be formatted for presentation to the renter via the GUI displayed by UE 102. Further, the transaction data may be used to calculate any remaining balances, as needed, and remind a renter of a date that a next transaction will occur according to a schedule defined by the established rent payment policy.

In some embodiments, RPMS 110 may be configured to communicate an electronic alert message at a designated time (e.g., a day before the rent due date, a week before the rent due date, etc.) to a landlord entity in the event a renter does not have sufficient funds earmarked/designated for rent payment in the payment card account, so that the landlord entity can proactively address the situation (e.g., contact renter before rent is due).

Notably, network entities, including host server 106 and RPMS 110, are special purpose computing devices or machines that each includes hardware components (e.g., one or more processor units, memory, and/or network interfaces) configured to execute hardware and software elements (e.g., APIs, computing modules, etc.) for the purposes of performing one or more aspects of the disclosed subject matter. In addition, it should be noted that host server 106 and RPMS 110, the functionality and/or components thereof described herein constitute special purpose computers that improve the technological field of electronic rent settlement and/or electronic guaranteed rent payment transactions by obviating the need for manually collecting payments, and providing mechanisms for electronically collecting and accumulating portions of rent payments periodically made by renters at a single platform, allocating or applying liens/holds to funds for rent payments, and then settling the rent transactions on a recurring basis.

It will be appreciated that FIG. 1 is for illustrative purposes only and that various entities, their locations, and/or their functions described above in relation to FIG. 1 may be changed, altered, added, or removed. For example, some components and/or functions may be separated or combined into one entity, e.g., host server 106, RPMS 110, or some functionality thereof may be integrated with any other entities associated with system 100.

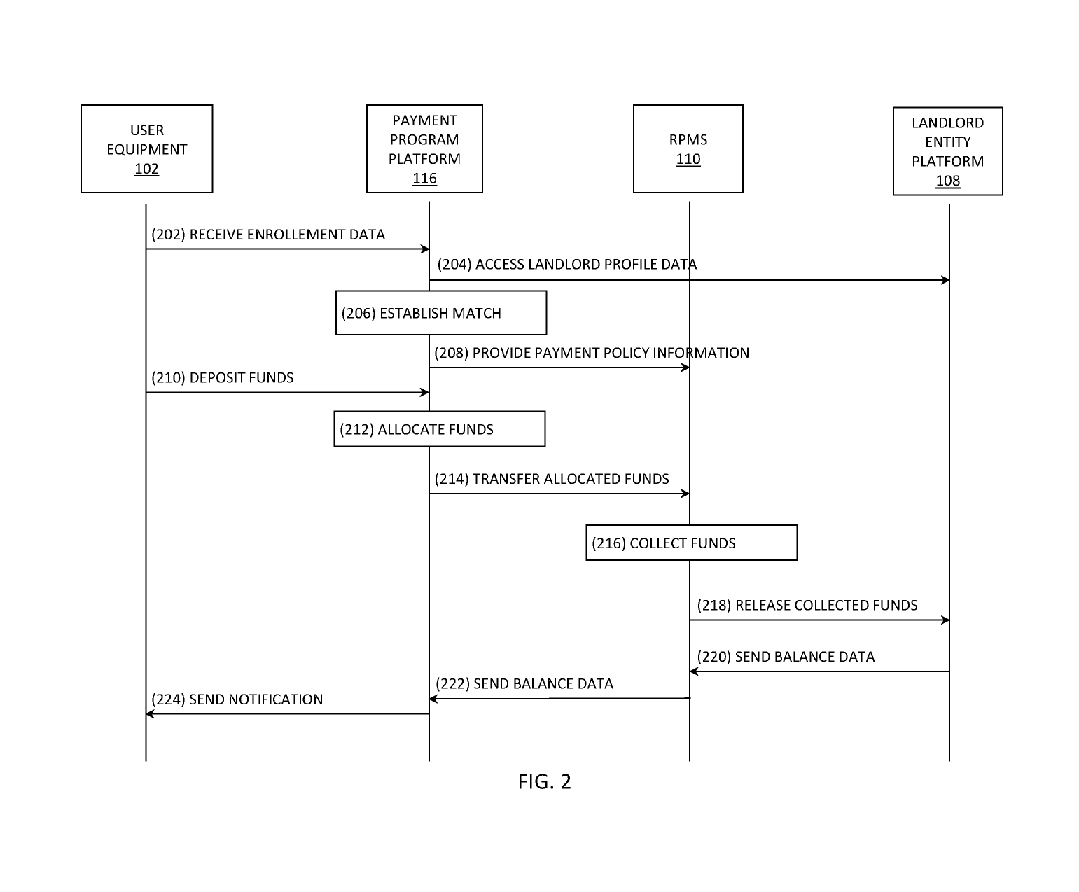

FIG. 2 is a diagram illustrating exemplary electronic messaging exchanged between various network entities for implementing guaranteed payment of rent according to an embodiment of the subject matter described herein. Namely, the system entities associated with electronic rent payment transactions include UE 102 (utilized by a renter or user), payment program platform 116, landlord entity platform 108, and RPMS 110 (i.e., the same elements described above with regard to FIG. 1).

At line 202, payment program platform 116 receives enrollment data from a prospective renter. For example, a renter utilizes UE 102 to enroll, register and/or create a renter profile/account with payment program platform 116. In some embodiments, the renter profile includes renter criteria that includes conditions and terms associated with a possible rental property the renter desires.

At line 204, payment program platform 116 may query and/or access landlord entity profiles stored by landlord entity platform 108 to inspect the profile entries in landlord profile database 126 in an attempt to find a suitable rental property for the prospective renter based on similar criteria (e.g., rental agreement criteria established by the landlord entity). Notably, database 126 includes landlord entity profile entries that respectively include rental agreement criteria. In particular, the rental agreement criteria includes conditions and terms the landlord entity is requesting in order to enter a lease for a rental property.

At block 206, payment program platform 116 compares and/or contrasts the renter criteria associated with the renter's profile to the rental agreement criteria contained in the landlord entity profile database 126. If the renter criteria associated with the renter's profile matches (or nearly matches) the rental agreement criteria of a landlord entity profile entry in database 126, payment program platform 116 may deem the rental property associated with the landlord entry profile a match. If a match is established, the renter may be notified of the match by payment program platform 116, which also confirms whether the renter wishes to rent the identified rental property. Notably, the renter, via UE 102, may indicate and/or confirm this desire to enter a lease for the identified rental property and agree to participate in a predefined rent payment schedule that involves placing a hold on monetary funds that are earmarked for specifically paying rent payments according to the payment schedule.

At line 208, payment program platform 116 provides rent payment policy data to RPMS 110. In some embodiments, payment program platform 116 transmits a rent payment policy record that includes information such as a rent amount (e.g., an amount owed), an identifier associated with the landlord entity entitled to the rent, the rent transaction and/or settlement date, and a payment card account number associated with the renter to RPMS 110.

At line 210, UE 102 communicates monetary fund data to host server 106. For example, payment program platform 116 receives the monetary fund deposit directed to the payment card account from a renter using UE 102 (e.g., a mobile phone deposit). Alternatively, the deposit of monetary funds into the renter's payment card account may originate from a third party, such as the renter's employer or a government agency.

At block 212, payment program platform 116 allocates the deposited monetary funds. In some embodiments, payment program platform 116 may be configured to designate or allocate monetary funds in the event the monetary funds are deposited into a renter's payment card account. For example, payment program platform 116 may be configured to access the rent payment criteria associated with the renter and subsequently allocate the deposited monetary funds in accordance to allocation rules set forth in the accessed rent payment criteria (as described above).

At line 214, payment program platform 116 transfers the allocated monetary funds to RPMS 110. In some embodiments, RPMS 110 may be configured to periodically (per the rent agreement policy) query payment program platform 116 to determine if a monetary fund deposit was received. In other embodiments, payment program platform 116 may send a trigger message informing RPMS 110 that a monetary fund deposit was recently performed. In response, RPMS 110 may be configured to pull any monetary funds currently allocated for rent payment from the renter's payment card account.

At block 216, the monetary funds are collected. In some embodiments, after receiving the monetary funds, RPMS 110 may store the allocated funds in accordance to the previously received rent payment policy information. For example, RPMS 110 may store the designated monetary funds in escrow until the predefined date/time of release arrives. At that point in time, RPMS 110 is then configured to release the monetary funds that have been collected and stored for the renter entity (see line 218).

At line 218, RPMS 110 releases monetary funds that were previously collected or accumulated from the renter's payment card account to the landlord entities 108. In some embodiments, RMPS 110 determines the arrival of the rent transaction date/time and releases the previously accumulated monetary funds to the appropriate landlord entity (e.g., a bank account identified in the rent payment policy record) via landlord entity platform 108.

Upon receiving the monetary funds from RPMS 110, landlord entity platform 108 may conduct a settling of the outstanding balance of the renter's account. For example, landlord entity platform 108 may assess whether the received monetary amount matches or exceeds the rent amount due. If the received monetary amount does match or exceed the rent amount, then landlord entity platform 108 may be configured to send the rent balance data to the RPMS 110 via an electronic message 220. If the monetary amount fails to match or exceed the rent amount, landlord entity platform 108 is configured to send an electronic message 220 to RPMS 110 that indicates the remaining balance that is due.

In response to receiving message 220, RPMS 110 is configured to send the balance data information via message 222 to payment program platform 116 (e.g., see line 222). In some embodiments, RPMS 110 can send balance data information, which may include a transaction history, the renter's account balance, and/or other transaction information to payment program platform 116. Transaction information includes a transaction amount, a transaction date and/or time, a landlord identifier (e.g., an alphanumeric code associated with a landlord entity), a transaction code, a renter identifier, or the like.

Upon receiving the account balance data information in message 222, payment program platform 116 may be configured to send a notification message 224 to user equipment 102 to notify the renter whether the full rent amount has been paid or if there is an outstanding/remaining balance that is due to the landlord entity.

Communications exchanged between host server 106 and other network entities (e.g., 108 and 110) may include packets having payload data containing payment information (e.g., a payment card account number), rent payment amounts, a rent balance, a landlord entity identifier, transactional information, and/or renter identification information.

In some embodiments, in the event a determination is made that the monetary funds do not match or exceed the rent amount, a notification message may be sent to a third party lending entity (not shown). In particular, payment program platform 116 may direct a notification message to a third party lending entity that is specified in the rent payment policy. In response to receiving the notification message, the third party lending entity may be prompted to provide a loan (e.g., at a predetermined interest rate specified in the rent payment policy) in the amount of the outstanding rent balance to the renter's payment card account. Notably, such the renter must agree and/or be pre-approved to implement this optional mechanism.

The message flow illustrated in FIG. 2 is advantageous, as rent payments are transparent to all parties of the transaction, as renters (e.g., via 102 and payment program platform 116) and landlord entities (e.g., via platform 108) each know exactly when a rent payment is made or scheduled. Furthermore, by virtue of applying a hold on the renter's monetary funds in the renter's payment card account, RPMS 110 provides a landlord entity assurance that a renter will likely make or has made a rent payment. In some embodiments, RPMS 110 invokes an API to initiate settlement and/or the release of funds.

It will be appreciated that FIG. 2 is for illustrative purposes only and that various messages, message sequencing and/or message content described above in relation to FIG. 2 may be changed, altered, edited, or removed where necessary. For example, some messages may be separated or combined into more than one or less than one message.

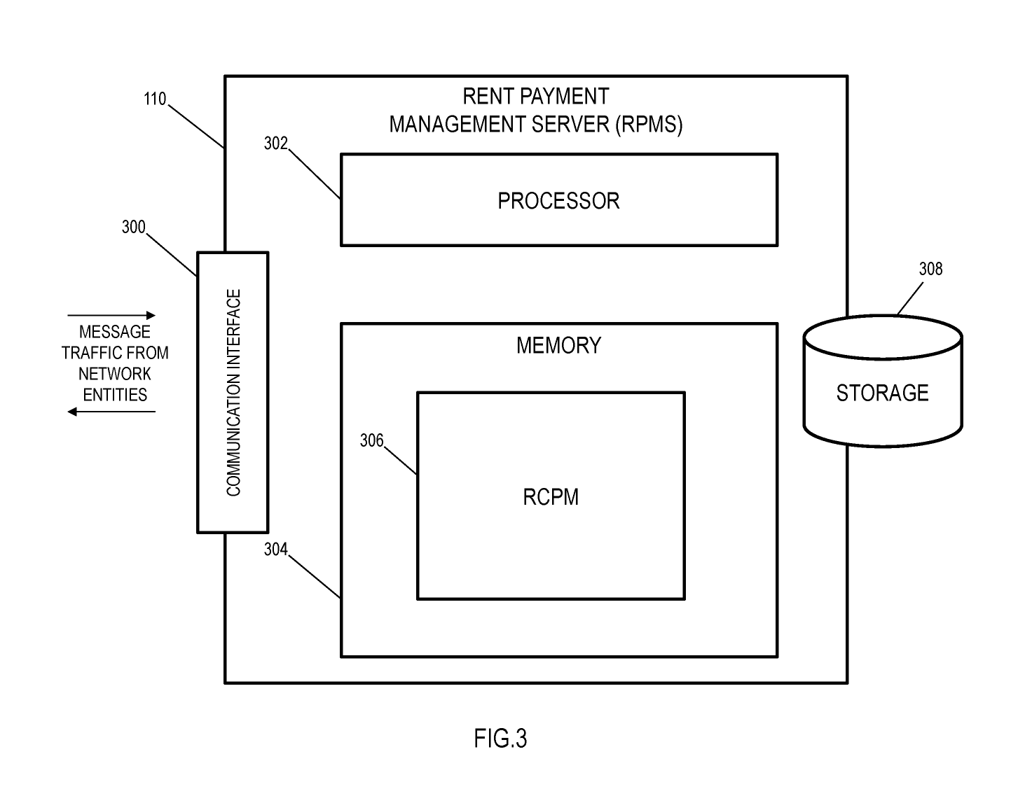

FIG. 3 is a block diagram illustrating an exemplary special purpose server for electronically guaranteeing rent payments according to an embodiment of the subject matter described herein. FIG. 3 illustrates RPMS 110, which includes a special purpose system or device for facilitating guaranteed payment of rent, in some aspects, by placing a hold on a renter's monetary funds, or otherwise earmarking the renter's funds for payment of a specific rent amount according to a predetermined schedule as defined by rent payment policy data.

In some embodiments, RPMS 110 includes at least one communication interface 300, at least one processor 302, and at least one memory 304 (e.g., a memory component, element or device). RPMS 110 is configured to utilize interface 300, processor 302, and memory 304 for executing an algorithm to communicate information (e.g., via an API-API exchange) between a payment program platform 116 and/or landlord entity platform 108 (supported on host server 106 as shown in FIG. 1) to implement guaranteed rent payment and settlement. In some embodiments, packets or message traffic (e.g., electronic payment requests, payment information, transaction information, or the like) is sent, received and/or otherwise communicated or exchanged between RPMS 110 and other network entities via communication interface 300. Although only one communications interface 300 is illustrated, one or more additional communications interfaces 300 may be provided whereby connections to the network 104 (as shown in FIG. 1) and other entities are established. That is, communications interface 300 may include an interface by which packet data messages are received, sent, and/or exchanged.

In some embodiments, communications interface 300 is utilized by RPMS 110 to transfer and exchange electronic payment information, electronic monetary funds, rent payment policy information, payment card account information, and any other information by which RPMS 110 can collect, store, and ultimately utilize to store and/or release monetary funds for facilitating the settlement of a rent payment. RPMS 110 is further configured to receive rent payment policy data which indicates that a renter authorizes a rent payment, to receive and payment information in order to make periodic rent payments, to pull designate monetary funds from a payment card account, and to place a hold on these funds designated for the rent payment. RPMS 110 is further configured to release the held monetary funds in accordance to a schedule defined in the rent payment policy information.

In some embodiments, processor 302 includes a microprocessor, such as a central processing unit (CPU), or any other hardware-based processor unit. Processor 302 is configured to execute and/or utilize software to communicate with host server 106 (as shown in FIG. 1) and any platforms associated therewith, for guaranteeing electronic payments, so that settlement of rent payment occurs according to a predetermined schedule in accordance with the established rent payment policy.

In some embodiments, RPMS 110 further comprises a rent collection and payment module (RCPM) 306 executed by processor 302 and stored in memory 304. RCPM 306 may include hardware, software and/or firmware components for implementing guaranteed payment of rent payments as described herein. In one exemplary implementation, RCPM 306 includes functionality for receiving rent payment policy information, applying liens or holds to monetary funds, and managing the funds for delivery to a landlord entity (e.g., a bank account belonging to a landlord entity via platform 108 as shown in FIG. 1). RCPM 306 is configured to store monetary funds obtained from host server 106 in storage 308 along with associated rent payment policy information. Storage 308 can comprise any type of storage element, component, or device, not limited to a database, a data table, a cache, a storage drive, or any other collection of records or information including payment information for processing on a periodic basis.

In some embodiments, RPMS 110 and/or RCPM 306 includes functionality for reading, parsing, and/or otherwise processing APIs to determine a payment amount and/or a date/time for releasing monetary funds to one or more landlord entities. Notably, RPMS 110 and/or RCPM 306 is configured to support various APIs and communicate with a host server (e.g., host server 106 in FIG. 1) to obtain/pull specific rent payment amounts and rent payment schedule defined in the rent payment policy data, as well as convey rent transaction information to host server 106 (see FIG. 1) after a rent payment is made.

In some embodiments, memory 304 (e.g., a memory element or device) of RPMS 110 includes a random access memory (RAM), a read only memory (ROM), an optical read/write memory, a cache memory, a magnetic read/write memory, a flash memory, or any other non-transitory storage media. In some embodiment, processor 302 and memory 304 may be used to execute and manage the operation of RCPM 306. In some embodiments, memory 304 and/or storage 308 include any medium that is configured to locally store rent payment policy data and rent transaction data used in processing payments and settlement to different landlord entities.

Although FIG. 3 depicts RPMS 110 as a single node or network element, RPMS 110 may alternatively comprise a plurality of network elements or components without departing from the scope of the present subject matter. In some embodiments, RPMS 110 collects designated monetary funds received from host server 106 for electronically guaranteeing rent payment. RPMS 110 may include multiple processors, memory elements, interfaces, or the like.

Notably, each of host server 106 and/or RPMS 110 is a special purpose computing device or machine having hardware components (e.g., one or more processor units, memory, and network interfaces) configured to execute hardware and software elements (e.g., APIs, packets, modules, etc.) for the purposes of performing one or more aspects of the disclosed subject matter. In addition, it should be noted that host server 106 and/or RPMS 110 and the components or functionality thereof constitute special purpose computers that improve the technological field pertaining to guaranteeing electronic payments for landlord entities by safeguarding the monetary funds until a settlement date that is established according to a predefined schedule. This obviates the need for manual processes and expands access of rental opportunities to individuals that may otherwise lack access.

It will be appreciated that FIG. 3 is for illustrative purposes only and that various components, their locations, and/or their functions described above in relation to FIG. 3 may be changed, altered, added, integrated, segregated, or removed. For example, some components and/or functions may be separated or combined into more than one entity.

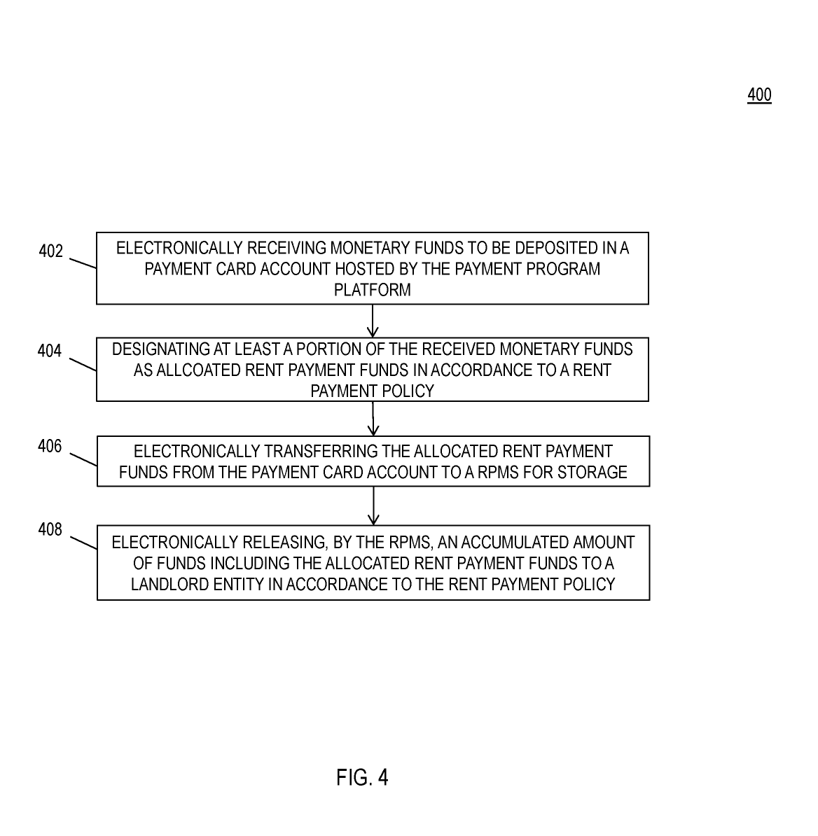

FIG. 4 is a diagram illustrating an exemplary method 400 for electronically guaranteeing rent payment according to an embodiment of the subject matter described herein. Electronic processes shown in method 400 and described herein advantageously obviate the need for manually processing rent payments.

In block 402, a payment program platform electronically receives monetary funds to be deposited in a payment card account hosted by the payment program platform. In some embodiments, a government entity and/or an employer of a user (e.g., a prospective renter or end-user) electronically deposits (e.g., direct deposit) monetary funds into a payment card account of the user. Similarly, the user himself may electronically deposit monetary funds into his payment card account.

In block 404, at least a portion of the received monetary funds are allocated as rent payment funds. In some embodiments, the payment program platform may allocate (e.g., earmark or tag) some or all of the monetary funds received in the payment card account via direct deposit. For example, the payment card account may be associated with a defined rent payment policy that was previously established upon the user's registration with a landlord entity.

In block 406, the allocated rent payment funds are electronically provided to an RMPS for storage. In some embodiments, the payment program platform (executed on a host server) transmits the allocated rent payment funds to the RMPS. Upon receipt, the RMPS may be configured to hold the rent payment funds in escrow until the rent due date. In some embodiments, the rent due date may be defined in rent payment policy record previously provided by the payment program platform. In some embodiments, rent transaction information is provided by the payment program platform to the RMPS along with the rent payment funds. Notably, the rent transaction information includes renter identification and/or account information and landlord identification and/or account information that can be used to apply the monetary funds to the renter's current rent balance. In some embodiments, electronically transferring the allocated monetary funds needed to pay the rent payment comprises pulling monetary funds from a renter's payment card account via APIs.

In block 408, an accumulated amount of funds is electronically released by the RPMS to the landlord entity. In some embodiments, the entire accumulated/collected amount of monetary funds stored and held by the RPMS on behalf of a renter is released to the appropriate landlord entity. Namely, the monetary funds are electronically submitted to an account (e.g., a payment card account or bank account) belonging to the landlord entity on a date and/or time defined in the aforementioned rent payment policy.

It will be appreciated that exemplary process 400 is for illustrative purposes only and that different and/or additional actions may be used. It will also be appreciated that various actions associated with exemplary process 400 may occur in a different order or sequence.

As noted above in FIGS. 1 and/or 3, host server 106 and/or RPMS 110 and/or the functionality of each as described herein constitute a special purpose computer. Further, it will be appreciated that host server 106 and/or RPMS 110 described herein can improve the technological field pertaining to packet communications for allocating funds used to settle rent payments. The coordination, scheduling, management, allocation, and settlement of rent payments via host server 106 and RPMS 110 is necessarily rooted in computer technology in order to overcome a problem specifically arising in the realm of computer networks, for example, by guaranteeing, via a computing platform, electronic payments via electronic fund allocation for facilitating rent payment.

Systems, methods, and computer readable media for electronically guaranteeing rent payment may provide, for example and without limitation, one or more of the following beneficial technical effects: facilitating electronic payments of monetary funds; guaranteeing electronic payments by electronically allocating or holding monetary funds; electronically placing and releasing liens on funds; minimizing and/or eliminating the need to manually process, deliver, and/or collect rent payments; electronically release funds for a specified amount according to a predetermined schedule; increased assurance that a renter can pay a rent amount; and/or payment systems that are more efficient, transparent, and/or beneficial to all parties to a transaction (e.g., the renter, collection host server, and/or landlord entity).

It will be understood that various details of the subject matter described herein may be changed without departing from the scope of the subject matter described herein. Furthermore, the foregoing description is for the purpose of illustration only, and not for the purpose of limitation. For example, various combinations and sub-combinations of the structures and features described herein are contemplated, and will be apparent to a skilled person having knowledge of this disclosure. Any of the various features and elements as disclosed herein can be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

What is claimed is:

1. A method for electronically guaranteeing rent payment, the method comprising:
electronically receiving, by a payment program platform, monetary funds to be deposited in a payment card account hosted by the payment program platform;
designating at least a portion of the received monetary funds as allocated rent payment funds in accordance to a rent payment policy;
electronically providing the allocated rent payment funds to a rent payment management server (RPMS) for storage; and
electronically releasing, by the RPMS, an accumulated amount of monetary funds that includes the allocated rent payment funds to a landlord entity in accordance to the rent payment policy.

2. The method of claim 1 wherein the RPMS stores the allocated rent payment funds in escrow until a date or time defined by the rent payment policy.

3. The method of claim 1 wherein the rent payment policy defines a percentage or an amount used to determine the at least a portion of the received monetary funds.

4. The method of claim 1 further comprising communicating rent transaction information to the payment program platform after electronically releasing the accumulated amount of monetary funds to the landlord entity.

5. The method of claim 4 wherein the rent transaction information includes at least one of a rent transaction amount, a rent transaction date, a landlord entity identifier, and a rent transaction identifier.

6. The method of claim 1 wherein electronically providing the allocated rent payment funds to the RPMS comprises electronically transmitting monetary funds from the payment card account via one or more application programming interfaces (APIs).

7. The method of claim 1 wherein the payment program platform and the RPMS communicate via a packet-based network.

8. A system for electronically guaranteeing rent payment, the system comprising:
a payment program platform configured to electronically receive monetary funds to be deposited in a payment card account hosted by the payment program platform and designate at least a portion of the received monetary funds as allocated rent payment funds in accordance to a rent payment policy; and
a rent payment management server (RPMS) comprising at least one processor, wherein the RPMS is configured to electronically receive the allocated rent payment funds for storage and to electronically release an accumulated amount of monetary funds that includes the allocated rent payment funds to a landlord entity in accordance to the rent payment policy.

9. The system of claim 8 wherein the RPMS is further configured to store the allocated rent payment funds in escrow until a date or time defined by the rent payment policy.

10. The system of claim 8 wherein the rent payment policy defines a percentage or an amount used to determine the at least a portion of the received monetary funds.

11. The system of claim 8 wherein the RPMS is further configured to communicate rent transaction information to the payment program platform after electronically releasing the accumulated amount of monetary funds to the landlord entity.

12. The system of claim 11 wherein the rent transaction information includes at least one of a rent transaction amount, a rent transaction date, a landlord entity identifier, and a rent transaction identifier.

13. The system of claim 8 wherein the payment program platform is further configured to electronically transmit monetary funds to the RPMS via one or more application programming interfaces (APIs).

14. The system of claim 8 wherein the payment program platform and the RPMS communicate via a packet-based network.

15. A non-transitory computer readable medium having stored thereon executable instructions that when executed by the processor of a computer control the computer to perform steps comprising:
electronically receiving, by a payment program platform, monetary funds to be deposited in a payment card account hosted by the payment program platform;
designating at least a portion of the received monetary funds as allocated rent payment funds in accordance to a rent payment policy;
electronically providing the allocated rent payment funds to a rent payment management server (RPMS) for storage; and
electronically releasing, by the RPMS, an accumulated amount of monetary funds that includes the allocated rent payment funds to a landlord entity in accordance to the rent payment policy.

16. The computer readable medium of claim 15 wherein the RPMS stores the allocated rent payment funds in escrow until a date or time defined by the rent payment policy.

17. The computer readable medium of claim 15 wherein the rent payment policy defines a percentage or an amount used to determine the at least a portion of the received monetary funds.

18. The computer readable medium of claim 15 further comprising communicating rent transaction information to the payment program platform after electronically releasing the accumulated amount of monetary funds to the landlord entity.

19. The computer readable medium of claim 18 wherein the rent transaction information includes at least one of a rent transaction amount, a rent transaction date, a landlord entity identifier, and a rent transaction identifier.

20. The computer readable medium of claim 15 wherein electronically providing the allocated rent payment funds to the RPMS comprises electronically transmitting monetary funds from the payment card account via one or more application programming interfaces (APIs).
